(19) United States
(12) Patent Application Publication
(10) Pub. No.: US 2021/0316286 A1
(43) Pub. Date: Oct. 14, 2021

(54) CORE-SHELL STRUCTURED NISE2@NC ELECTROCATALYTIC MATERIAL AND PREPARATION METHOD AND USE THEREOF

(71) Applicant: China University of Petroleum (East China), Qingdao (CN)

(72) Inventors: Ben XU, Qingdao (CN); Zhaodi HUANG, Qingdao (CN); Shuai YUAN, Qingdao (CN); Daofeng SUN, Qingdao (CN)

(73) Assignee: China University of Petroleum (East China), Qingdao (CN)

(21) Appl. No.: 17/224,998

(22) Filed: Apr. 7, 2021

(30) Foreign Application Priority Data
Apr. 14, 2020 (CN) 202010288134.3
Apr. 20, 2020 (CN) 202010309545.6

(51) Int. Cl. B01J 31/02; C25B 1/04; B01J 37/00; B01J 37/02; B01J 6/00; B01J 35/00; B01J 35/02

(52) U.S. Cl. CPC B01J 31/0235; C25B 1/04; B01J 37/0072; B01J 37/0219; B82Y 30/00; B01J 6/001; B01J 37/0225; B01J 35/0033; B01J 35/023; B01J 37/0221

(57) ABSTRACT

The present disclosure discloses a core-shell structured NiSe₂@NC electrocatalytic material having a general formula of NiSe₂@NC. The present disclosure also provides a preparation method and use of the catalytic material. In the present disclosure, hydrazine hydrate is used as a reducing agent, selenium powders are used as a source of selenium, and a metal-organic framework (MOF) is used as a precursor. Selective selenization of mixed-linker MOFs based on mixed ligands is carried out through a hydrothermal reaction. Then, a series of adjustable N-doped carbon-coated NiSe₂ nano-octahedrons are prepared through a one-step calcination reaction. By adjusting the types of mixed ligands in the MOF, carbon-coated nickel diselenide composites doped with different pyridinic-N contents can be obtained. Corresponding electrochemical tests prove that, the electrocatalytic activity has a strong correlation with the content of pyridinic-N.

### TECHNICAL FIELD

The present disclosure belongs to the technical field of synthesis and electrochemistry of nano materials for new energies, and specifically relates to a core-shell structured NiSe₂@NC electrocatalytic material and a preparation method and use thereof.

### BACKGROUND

Electrochemical water splitting through a hydrogen evolution reaction is an environmentally friendly and efficient strategy for hydrogen energy economy. Platinum-group metals are regarded as the most effective electrocatalysts, but their low abundance and high cost prevent them from large-scale applications. It is desirable to develop electrocatalysts which have abundant reserves and high activities, but it is a challenging task. Various catalysts based on non-noble metal materials such as transition metal hydroxides, nitrides, carbides and phosphides, have been studied as potential alternative materials for platinum-group metals. Among them, transition metal selenides (TMSs) attract researchers' attentions for their rich resources in earth and electrical conductivity. However, their further application is limited by their relatively low stability and poor activity under alkaline conditions. Therefore, it is necessary to optimize surface electronic structures of selenides. It has been demonstrated that hybridization with nitrogen (N)-doped carbon materials can activate a TMS by creating additional local reaction sites on a carbon-TMS interface, and stabilize the surface of the TMS by avoiding direct contact with an electrolyte. Generally, N species in the N-doped carbon may include pyridinic-N, pyrrole-N and graphite-N. For the N-doped carbon, the pyridinic-N may affect the electronic structure of the carbon material by increasing the p-state density near the Fermi level and reducing the work function, thereby enhancing the electrocatalytic activity of oxygen reduction. However, there is no systematic experimental and theoretical evidences suggesting the effect of pyridinic-N on electrocatalytic activities of carbon materials and its role in adjusting the electronic structures of the TMSs@NC interfaces and in synergistic electrocatalysis. This is mainly due to the difficulties in synthesizing TMSs@NC materials with controllable interface structures and tunable N-species. In view of this, we recommend using a metal-organic framework (MOF) as a platform for synthesis of TMSs@NC materials. MOFs are porous inorganic-organic hybrid materials including metal nodes and organic ligands, which have been used as precursors for various functional materials. The presence of metals and carbon/N-coordinating ligands makes the MOF an ideal platform for constructing metal nanoparticle composites coated with N-doped porous carbon. During typical synthesis of nano-hybrid materials, the MOFs are usually pyrolyzed in an inert atmosphere. For example, CoP@NC is synthesized through pyrolysis of Co²⁺-benzimidazole containing MOF (ZIF-9) followed by a phosphating reaction. Similarly, NiSe₂@NC is obtained by pyrolysis and selenization of Ni-MOF. The porosity of the MOFs allows formation of porous structures of metal compounds with carbon as a carrier, thereby promoting electrocatalytic applications. However, the irregular morphology of metal compounds hinders recognition of active sites. Moreover, during a direct pyrolysis process, it is often difficult to control the type and content of N in the carrier.

Therefore, preparation of an ideal new N-doped carbon-coated nickel diselenide electrocatalytic material for hydrogen evolution with an adjustable interface structure is a challenging research topic in this field.

### SUMMARY

The present disclosure provides a core-shell structured NiSe₂@NC electrocatalytic material and preparation method and use thereof. It solves current problems related to active sites of such materials and adjustment of these active sites.

The present disclosure is achieved by the following technical solutions:

A core-shell structured NiSe₂@NC electrocatalytic material, having a general formula of NiSe₂@NC.

A method for preparing the NiSe₂@NC-X electrocatalytic material for hydrogen evolution as described above, including:

S1: carrying out a solvothermal reaction to prepare a nickel-based metal organic framework precursor denoted as Ni-MOF-X;

S2: dissolving the prepared nickel-based metal organic framework precursor in water to obtain a uniform MOF aqueous solution, dispersing selenium powders in hydrazine hydrate and dripping into the MOF aqueous solution, mixing uniformly, carrying out a hydrothermal reaction at 100-160° C. for 12-72 h to obtain an X@NiSe₂ precursor;

S3: heating the X@NiSe₂ precursor to 330-450° C. at a heating rate of 1-5° C.·min⁻¹ under protection of N₂, holding the temperature for 30-120 min for annealing, and cooling to room temperature to obtain a NiSe₂@NC electrocatalytic material for hydrogen evolution;

where, X is one of 4,4′-bipyridine (BP for short), 1,4-diazabicyclooctane (DO for short), pyrazine (PZ for short), and aminopyrazine (AE for short).

As a preferred solution, the MOF precursor in S1 may be prepared by:

dissolving nickel nitrate, trimesic acid and N-coordinating ligands in N, N-dimethylformamide, mixing uniformly, and carrying out a reaction at 100-130° C. for 24-72 h to obtain the nickel-organic framework precursor.

As a preferred solution, the N-coordinating ligand may be one of BP, DO, PZ and AE.

Use of the above core-shell structured NiSe₂@NC electrocatalytic material in electrocatalytic decomposition of water to produce hydrogen is also provided.

A reaction mechanism of the present disclosure is described as follows:

Selective selenization of mixed-linker MOFs by the hydrothermal reaction allows Se₂²⁻ to substitute anionic carboxylate ligands while obtaining neutral N-coordinated ligands in a NiSe₂ nanocrystal. Then, a one-step calcination reaction is carried out to obtain a series of N-doped carbon coated NiSe₂ nano-octahedrons with an adjustable pyridinic-N content.

Compared with the prior art, the present disclosure has the following advantages and positive effects.

In the present disclosure, a N-doped carbon coated NiSe₂ nano-octahedron electrocatalytic material for hydrogen evolution can be derived from mixed ligand-based selective selenization of a mixed-linker MOF, and includes an adjustable interface structure. A series of core-shell nanocubes with different pyridinic-N contents can be prepared by changing the types of N-coordinating ligands for use in synthesis of the MOF precursor, which enables controllable synthesis of N-doped carbon-coated transition metal selenides. The obtained NiSe₂@NC-X, especially when X=PZ, can be used as a highly efficient catalyst for electrocatalytic water splitting.

### BRIEF DESCRIPTION OF THE DRAWINGS

Other features, objectives and advantages of the present disclosure will become more apparent upon reading the detailed description of the non-restrictive embodiments with reference to the following accompanying drawings.

FIG. 1 is a scanning electron microscope (SEM) image of the PZ@NiSe₂ having a nano-octahedron structure prepared in Example 1 of the present disclosure;

FIG. 2 is a transmission electron microscope (TEM) image of the PZ@NiSe₂ having a nano-octahedron structure prepared in Example 1 of the present disclosure;

FIG. 3 is a high-resolution TEM (HRTEM) image of the PZ@NiSe₂ having a nano-octahedron structure prepared in Example 1 of the present disclosure;

FIG. 4 is a selected area electron diffraction (SAED) image of the PZ@NiSe₂ having a nano-octahedron structure prepared in Example 1 of the present disclosure;

FIG. 5 is an SEM image of the NiSe₂@NC-PZ having a nano-octahedron structure prepared in Example 2 of the present disclosure;

FIG. 6 is a TEM image of the NiSe₂@NC-PZ having a nano-octahedron structure prepared in Example 2 of the present disclosure;

FIG. 7 is an HRTEM image of the NiSe₂@NC-PZ having a core-shell nano-octahedron structure prepared in Example 2 of the present disclosure;

FIG. 8 is an SAED image of the NiSe₂@NC-PZ having a core-shell nano-octahedron structure prepared in Example 2 of the present disclosure;

FIG. 9 is element maps of the NiSe₂@NC-PZ having a core-shell nano-octahedron structure prepared in Example 2 of the present disclosure;

FIG. 10 shows X-ray diffraction (XRD) spectra of the PZ@NiSe₂ and the NiSe₂@NC-PZ having core-shell nano-octahedron structures prepared in Examples 1-2 of the present disclosure;

FIG. 11 shows the ¹H nuclear magnetic resonance (′H NMR) spectrum of the Ni-MOF-PZ prepared in Example 1 of the present disclosure;

FIG. 12 shows the ¹H NMR spectrum of the PZ@NiSe prepared in Example 1 of the present disclosure;

FIG. 13 shows the ¹H NMR spectrum of the NiSe₂@NC-PZ prepared in Example 2 of the present disclosure;

FIG. 14 shows SEM images of the electrocatalytic materials prepared in Comparative Examples 1-3 of the present disclosure;

FIG. 15 shows linear sweep voltammetry (LSV) curves of the electrocatalytic materials prepared in Examples 1-2 and Comparative Examples 1-3 in the present disclosure;

FIG. 16 shows Tafel slopes of the electrocatalytic materials prepared in Examples 1-2 and Comparative Examples 1-3 in the present disclosure;

FIG. 17 shows relationship between content of pyridinic-N in electrocatalytic materials prepared in Examples 1-2 and Comparative Examples 1-3 in the present disclosure and overpotential at a current density of 10 mA·cm⁻²;

FIG. 18 shows electrochemical double layer capacitance of the electrocatalytic materials prepared in Examples 1-2 and Comparative Examples 1-3 in the present disclosure; and

FIG. 19 shows stability test of the electrocatalytic materials prepared in Examples 1-2 and Comparative Examples 1-3 in the present disclosure.

### DETAILED DESCRIPTION

The present disclosure will be described in detail below with reference to specific embodiments. The following embodiments will help those skilled in the art to further understand the disclosure, but do not limit the disclosure in any way. It should be noted that those of ordinary skill in the art can further make several variations and improvements without departing from the idea of the disclosure. These variations and improvements all fall within the protection scope of the disclosure.

### Example 1

This example provided a method for preparing a PZ@NiSe₂ precursor, specifically including the following steps:

Step (1): preparation of Ni-MOF precursor: 0.5 mmol of nickel nitrate hexahydrate, 0.5 mmol of trimesic acid and 0.5 mmol of PZ were dissolved in 10 mL of N, N-dimethylformamide solution. The mixture was further stirred for 30 min until it was completely dissolved at room temperature. Then, a green solution was transferred to a 25 mL polytetrafluoroethylene stainless steel autoclave and kept at 130° C. for 72 h. Finally, a large amount of a mixed solution of N, N-dimethylformamide and methanol was used for centrifugation to obtain a Ni-MOF precursor denoted as Ni-MOF-PZ.

Step (2): preparation of PZ@NiSe₂ precursor: 50 mg of Ni-MOF-PZ was dissolved in 10 mL of deionized water. 1.5 mmol of selenium powders was added to 5.0 mL of hydrazine hydrate (85%). Then vigorous stirring was carried out at room temperature, and a hydrazine hydrate-selenium solution was dripped to an MOF aqueous solution. 180 min later, a mixture was transferred to a 23 mL polytetrafluoroethylene lined autoclave and heated at 100° C. for 12 h. After completion of the reaction, the mixture was cooled to room temperature.

FIG. 1 was an SEM image of the PZ@NiSe₂ having a nano-octahedron structure prepared in Example 1. It can be seen that, the synthesized PZ@NiSe₂ had a regular polyhedron structure.

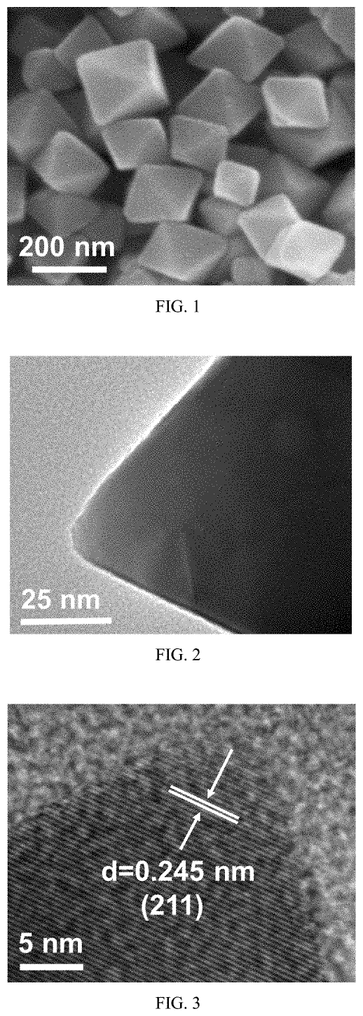

FIG. 2 was a TEM image of the PZ@NiSe₂ having a nano-octahedron structure prepared in Example 1, showing that the synthesized PZ@NiSe₂ had a side length of about 150 nm.

FIG. 3 was an HRTEM image of the PZ@NiSe₂ having a nano-octahedron structure prepared in Example 1, showing that the synthesized PZ@NiSe₂ had cubic NiSe₂.

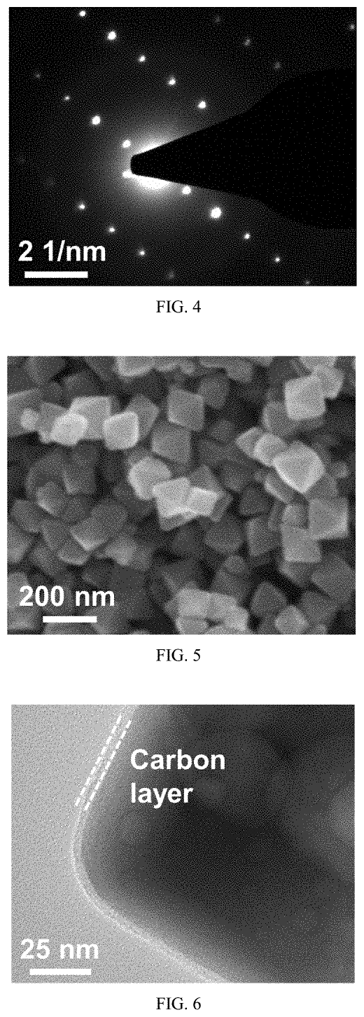

FIG. 4 was an SAED image of the PZ@NiSe₂ having a nano-octahedron structure prepared in Example 1, showing that the synthesized PZ@NiSe₂ was at a single crystal state.

### Example 2

This example provided a method for preparing a core-shell structured NiSe₂@NC electrocatalytic material, specifically including the following steps:

The PZ@NiSe₂ prepared in Example 1 was annealed at 450° C. for 30 min at a heating rate of 1° C.·min⁻¹ under a N₂ atmosphere to obtain a final NiSe₂@NC denoted as NiSe₂@NC-PZ.

FIG. 5 was an SEM image of the NiSe₂@NC-PZ having a nano-octahedron structure prepared in Example 2, showing that the synthesized PZ@NiSe₂ maintained the regular polyhedron morphology of the precursor.

FIG. 6 was a TEM image of the NiSe₂@NC-PZ having a nano-octahedron structure prepared in Example 2, showing formation of an ultra-thin carbon layer (about 1.5 nm).

FIG. 7 was an HRTEM image of the NiSe₂@NC-PZ having a core-shell nano-octahedron structure prepared in Example 2, showing that the 0.243 nm lattice fringe matched well with the 211 crystal plane of cubic NiSe₂.

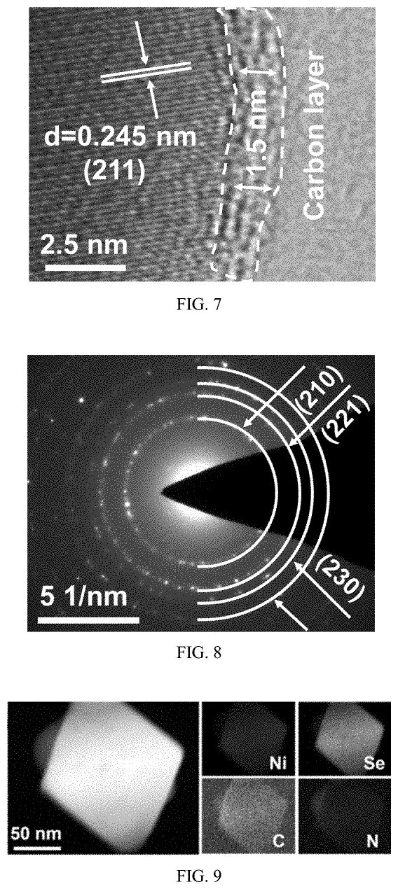

FIG. 8 was an SAED image of the NiSe₂@NC-PZ having a core-shell nano-octahedron structure prepared in Example 2, showing that the synthesized NiSe₂@NC-PZ was at a polycrystalline state.

FIG. 9 was element maps of the NiSe₂@NC-PZ having a core-shell nano-octahedron structure prepared in Example 2 of the present disclosure, showing uniform distribution of Se, Ni, C and N elements.

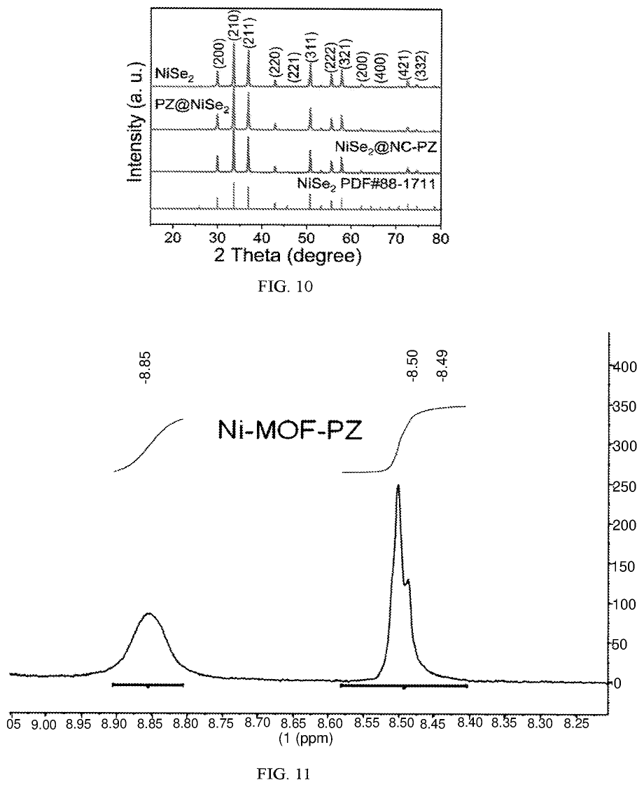

FIG. 10 showed XRD spectra of the PZ@NiSe₂ and the NiSe₂@NC-PZ having nano-octahedron structures prepared in Examples 1-2 of the present disclosure, demonstrating formation of cubic NiSe₂.

In order to facilitate the test to obtain an NMR spectrum, a mortar was used to grind solid samples such as Ni-MOF-PZ and NiSe₂@NC-PZ. 5-10 mg of sample was placed in a clean NMR tube (5 mm). Then DMSO-d₆ (0.5-1 mL) and H₂SO₄-d₂ (0.1-0.2 mL) were added. The NMR tube was gently shaken or ultrasonicated for 10-30 s until no obvious suspended solid particles were observed. Moreover, a supernatant from Ni-MOF-PZ solvothermal selenization was also collected and neutralized with HCl (2.0 M). A precipitate formed was filtered, washed, dried, and also used for ¹H NMR analysis.

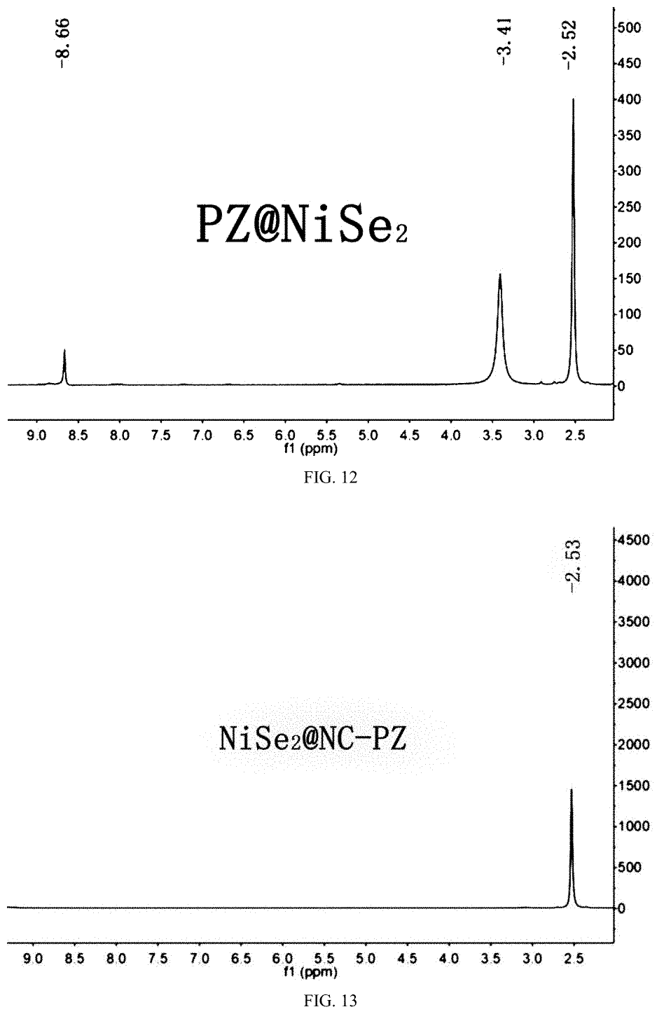

FIGS. 11-13 showed the ¹H NMR spectra of the PZ@NiSe₂ and the NiSe₂@NC-PZ with core-shell nano-octahedron structures prepared in Examples 1-2 of the present disclosure. It was verified that Ni-MOF-PZ contained equal proportions of trimesic acid and PZ ligands. After hydrothermal selenization, only the nuclear magnetic peak of trimesic acid remained in the supernatant. It was verified in turn that PZ-embedded NiSe₂ nano-octahedrons were generated and named PZ@NiSe₂. After calcination in a tube furnace, a NiSe₂@NC-PZ product was obtained, and only the peak of DMSO-d₆ was left. The nuclear magnetic peak of PZ disappeared. It was verified that, during the calcination, the PZ was converted into an ultra-thin N-doped carbon layer.

### Comparative Example 1

The only difference between this Comparative Example and Example 2 was that BP was used instead of PZ in preparation of the Ni-MOF precursor, and the obtained NiSe₂@NC was denoted as NiSe₂@NC-BP.

### Comparative Example 2

The only difference between this Comparative Example and Example 2 was that DO was used instead of PZ in preparation of the Ni-MOF precursor, and the obtained NiSe₂@NC was denoted as NiSe₂@NC-DO.

### Comparative Example 3

The only difference between this Comparative Example and Example 2 was that AE was used instead of PZ in preparation of the Ni-MOF precursor, and the obtained NiSe₂@NC was denoted as NiSe₂@NC-AE.

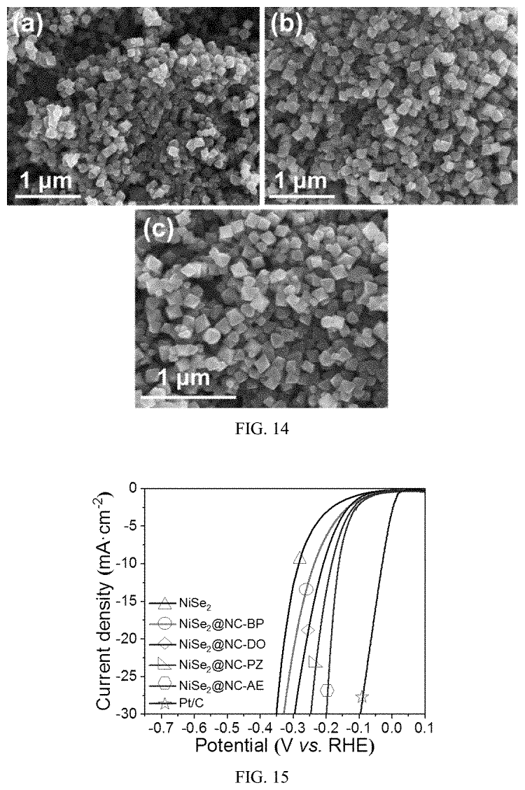

FIG. 14 showed SEM images of the electrocatalytic materials NiSe₂@NC-BP, NiSe₂@NC-DO and NiSe₂@NC-AE prepared in Comparative Examples 1-3 in the present disclosure, all showing a uniform regular octahedral morphology which can eliminate effects of morphology and size on electrocatalytic performance.

### Example 4

In a standard three-electrode test system, a graphite rod was used as a counter electrode, a Ag/AgCl electrode filled with saturated KCl was used as a reference electrode, and a glassy carbon electrode was used as a working electrode. 5.0 mg of prepared sample was dispersed in a mixed solution of 0.5 mL of Nafion solution (5% (w/w)), deionized water and ethanol (in a volume ratio of 1:9:10), and ultrasonicated to form a uniform solution. Then, 5 μL of solution was dripped on a glassy carbon electrode having a 3 mm diameter. The electrode was allowed to dry naturally at room temperature for 2 h, and used for measurement (loading capacity: 0.35 mg·cm⁻²).

FIG. 15 showed the linear sweep voltammetry (LSV) curves of the electrocatalytic materials prepared in Examples 1-2 and Comparative Examples 1-3. It was verified that, compared with the NiSe₂@NC-BP (235 mV), the NiSe₂@NC-DO (208 mV), the NiSe₂@NC-AE (182 mV) and bare NiSe₂ (283 mV), the NiSe₂@NC-PZ nanomaterial showed the highest activity at 10 mA·cm⁻², with an overpotential of 162 mV.

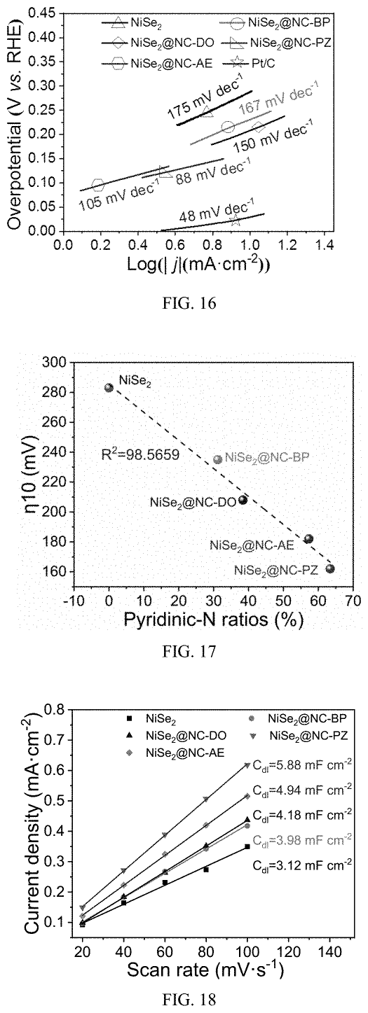

FIG. 16 showed Tafel slopes of the electrocatalytic materials prepared in Examples 1-2 and Comparative Examples 1-3, where the fitted Tafel slope of NiSe₂@NC-PZ was 88 mV·dec⁻¹. This demonstrated that, compared with other NiSe₂@NC nanomaterials, the NiSe₂@NC-PZ material was faster in reaction kinetics, and its reaction mechanism was a Volmer-Heyrovsky joint mechanism.

FIG. 17 showed relationship between the pyridinic-N content of the electrocatalytic materials prepared in Examples 1-2 and Comparative Examples 1-3 and the overpotential at a current density of 10 mA cm⁻². It was verified that the HER activity correlated to the pyridinic-N content of NiSe₂@NC nanohybrids linearly in an alkaline medium, indicating that the HER activity under alkaline conditions was mainly determined by the pyridinic-N content.

FIG. 18 showed electrochemical double layer capacitance of the electrocatalytic materials prepared in Examples 1-2 and Comparative Examples 1-3, demonstrating that the NiSe₂@NC-PZ nanohybrid had a slightly higher amount of available surface active sites.

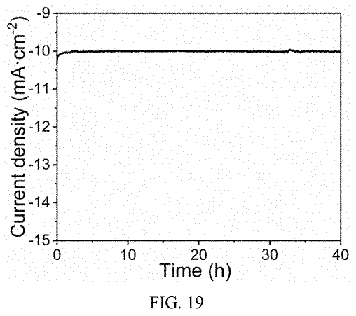

FIG. 19 showed stability test of the electrocatalytic materials prepared in Examples 1-2 and Comparative Examples 1-3, demonstrating that the NiSe₂@NC-PZ nanomaterial had desired stability in an alkaline medium.

Specific embodiments of the present disclosure are described above. It should be understood that the present disclosure is not limited to the above specific embodiments, and those skilled in the art can make various variations or modifications within the scope of the claims, which does not affect the essence of the present disclosure.

What is claimed is:

1. A core-shell structured NiSe₂@NC electrocatalytic material, having a general formula of NiSe₂@NC.

2. A method for preparing the core-shell structured NiSe₂@NC electrocatalytic material according to claim 1, comprising the following steps:
S1: carrying out a solvothermal reaction to prepare a nickel-based metal organic framework precursor denoted as Ni-based metal-organic framework-X (Ni-MOF-X);
S2: dissolving the prepared nickel-based metal organic framework precursor in water to obtain a uniform MOF aqueous solution, dispersing selenium powders in hydrazine hydrate and dripping into the MOF aqueous solution, mixing uniformly, carrying out a hydrothermal reaction at 100-160° C. for 12-72 h to obtain an X@NiSe₂ precursor; and
S3: heating the X@NiSe₂ precursor to 330-450° C. at a heating rate of 1-5° C.·min⁻¹ under protection of N₂, holding the temperature for 30-120 min for annealing, and cooling to room temperature to obtain a NiSe₂@NC electrocatalytic material for hydrogen evolution;
wherein, X is one of 4,4′-bipyridine (BP), 1,4-diazabicyclooctane (DO), pyrazine (PZ), and aminopyrazine (AE).

3. The method for preparing the core-shell structured NiSe₂@NC electrocatalytic material according to claim 2, wherein, the MOF precursor in S1 is prepared by:
dissolving nickel nitrate, trimesic acid and N-coordinating ligands in N, N-dimethylformamide, mixing uniformly, and carrying out a reaction at 100-130° C. for 24-72 h to obtain the nickel-based metal organic framework precursor.

4. The method for preparing the core-shell structured NiSe₂@NC electrocatalytic material according to claim 2, wherein the N-coordinating ligands is one of BP, DO, PZ and AE.

5. Use of the core-shell structured NiSe₂@NC electrocatalytic material according to claim 1 in electrocatalytic decomposition of water to produce hydrogen.

6. The method for preparing the core-shell structured NiSe₂@NC electrocatalytic material according to claim 3, wherein the N-coordinating ligands is one of BP, DO, PZ and AE.
